(19) United States
(12) Patent Application Publication
(10) Pub. No.: US 2024/0330660 A1
(43) Pub. Date: Oct. 3, 2024

(54) NEURAL NETWORK INCLUDING LOCAL STORAGE UNIT

(71) Applicant: STMicroelectronics International N.V., Geneva (CH)

(72) Inventors: Carmine CAPPETTA, Battipaglia (IT); Surinder Pal SINGH, Noida (IN); Giuseppe DESOLI, San Fermo Della Battaglia (IT); Thomas BOESCH, Rovio (CH); Michele ROSSI, Bareggio (IT)

(73) Assignee: STMicroelectronics International N.V., Geneva (CH)

(21) Appl. No.: 18/426,128

(22) Filed: Jan. 29, 2024

Related U.S. Application Data
(63) Continuation-in-part of application No. 18/194,108, filed on Mar. 31, 2023.

(51) Int. Cl. G06N 3/0464; G06N 3/063

(52) U.S. Cl. CPC G06N 3/0464; G06N 3/063

(57) ABSTRACT

A neural network includes an internal storage unit. The internal storage unit stores feature data received from a memory external to the neural network. The internal storage unit reads the feature data to a hardware accelerator of the neural network. The internal storage unit adapts a storage pattern of the feature data and a read pattern of the feature data to enhance the efficiency of the hardware accelerator.

### BACKGROUND

### Technical Field

The present disclosure generally relates to neural networks, and more particularly to convolutional neural networks (CNNs).

### Description of the Related Art

Deep learning algorithms promote very high performance in numerous applications involving recognition, identification and/or classification tasks, however, such advancements may come at the price of significant usage of processing power. Thus, their adoption can be hindered by a lack of availability of low-cost and energy-efficient solutions. Accordingly, severe performance specifications may coexist with tight constraints in terms of power and energy consumption while deploying deep learning applications on embedded devices.

CNNs are a type of Deep Neural Networks (DNN). Their architecture is characterized by Convolutional Layers and Fully Connected Layers. The former layers carry on convolution operations between layer's inputs and convolutional kernels, nonlinear activation functions (such as rectifiers) and max pooling operations, which are usually the most demanding ones in terms of computational effort.

### BRIEF SUMMARY

In one embodiment, a method includes receiving, at a neural network, feature data from a memory external to the neural network, passing the feature data to an internal storage of the neural network, and storing, with a write transformer unit of the internal storage, the feature data in the internal storage with a first address configuration based on a first hardware accelerator that is next in a flow of the neural network. The method includes passing the feature data from the internal storage to the first hardware accelerator and generating first transformed feature data by processing the feature data with the first hardware accelerator.

In one embodiment, a method includes receiving, at a neural network, feature data from a memory external to the neural network and passing the feature data to an internal storage of the neural network. The method includes storing the feature data in the internal storage and reading, with a read transformer unit of the neural network, the feature data to a first hardware accelerator with a read address pattern based on an operation of the first hardware accelerator. The method includes generating first transformed feature data by processing the feature data with the first hardware accelerator.

In one embodiment, a device includes a neural network. The neural network includes a stream engine configured to receive feature data from a memory external to the neural network, a hardware accelerator, and an internal storage configured to receive the feature data from the stream engine. The internal storage includes a write transformer unit configured to write the feature data into the internal storage with a write address pattern based on a configuration of the hardware accelerator. The internal storage includes a read transformer unit configured to read the feature data to the hardware accelerator with a read address pattern based on the configuration of the hardware accelerator, the hardware accelerator configured to receive the feature data from the internal storage, to process the feature data to generate transformed feature data.

In one embodiment, a method includes receiving, at a neural network, feature data from a memory external to the neural network, passing the feature data to an internal storage of the neural network, and storing the feature data in a memory of the internal storage. The method includes passing, with a read transformer unit of the internal storage, the feature data to a plurality of registers of the internal storage and passing the feature data from the registers to a hardware accelerator of the neural network.

In one embodiment, a method includes receiving, at a neural network, feature data arranged in rows and columns from a memory external to the neural network and passing the feature data to an internal storage of the neural network. The method includes storing, with a write transformer unit of the internal storage, the feature data in a memory of in the internal storage by at least partially transposing the rows and columns of the feature data. The method includes passing the feature data from the memory of the internal storage to a hardware accelerator and generating first transformed feature data by processing the feature data with the hardware accelerator.

In one embodiment, a device includes a neural network. The neural network includes a stream engine configured to receive feature data from a memory external to the neural network, a hardware accelerator, and an internal storage configured to receive the feature data from the stream engine. The internal storage includes a memory configured store the feature data, a plurality of registers coupled to the memory, and a read transformer unit configured to read the feature data to the hardware accelerator including passing the feature data from the memory to the plurality of registers.

### BRIEF DESCRIPTION OF THE SEVERAL VIEWS OF THE DRAWINGS

FIG. 1 is a block diagram of an electronic device, according to some embodiments.

FIG. 2 is a block diagram of process flow within a neural network, according to some embodiments.

FIG. 3 is a block diagram of a portion of a neural network, according to some embodiments.

FIG. 4 is a representation of a feature tensor, according to some embodiments.

FIG. 5 is a representation of a feature tensor and sub-tensors extracted from the feature tensor, according to some embodiments.

FIG. 6 is a representation of a feature tensor and sub-tensors extracted from the feature tensor, according to some embodiments.

FIG. 7 is a block diagram of an internal storage of a neural network, according to some embodiments.

FIG. 8 is an illustration of memory being read from an internal storage of a neural network, according to some embodiments.

FIG. 9 is an illustration of memory being read from an internal storage of a neural network, according to some embodiments.

FIG. 10 is a block diagram of a read transformer unit of an internal storage, according to some embodiments.

FIGS. 11A-11C are illustrations of a memory of an internal storage, according to some embodiments.

FIGS. 12A-12D are illustrations of a memory and registers of an internal storage, according to some embodiments.

FIG. 13 is an illustration of a memory of an internal storage utilizing a reading scheme, according to some embodiments.

FIG. 14 is an illustration of a memory of an internal storage utilizing a reading scheme, according to some embodiments.

FIGS. 15A-15I are illustrations of registers of a read transformer unit of a local storage, according to some embodiments.

FIG. 16 is a flow diagram of method for operating a CNN, according to some embodiments.

FIG. 17 is a flow diagram of a method for operating a CNN, according to some embodiments.

FIG. 18 is a flow diagram of a method for operating a CNN, according to some embodiments.

FIG. 19 is a flow diagram of a method for operating a CNN, according to some embodiments.

### DETAILED DESCRIPTION

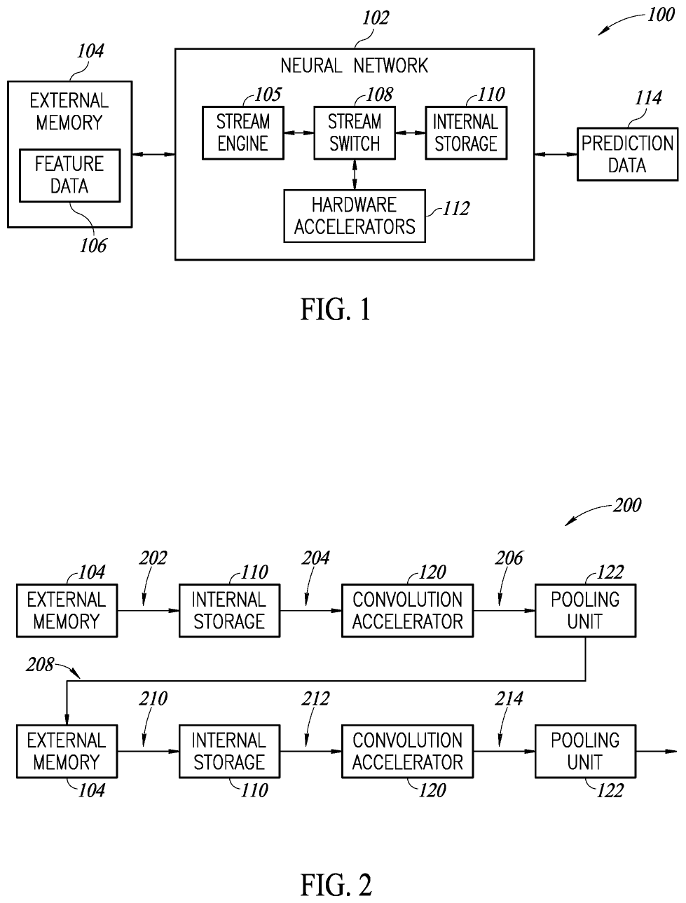

FIG. 1 is a block diagram of an electronic device 100, according to some embodiments. The electronic device 100 includes a neural network 102 and an external memory 104. The external memory 104 includes feature data 106 for processing by the neural network 102. The neural network 102 receives the feature data 106 from the external memory 104 and generates prediction data 114 based on the feature data 106. As will be set forth in more detail below, the components of the neural network 102 cooperate to provide effective and efficient processing of feature data 106.

In a neural network, feature data may be read multiple times from an external memory. However, reading data from the external memory may utilize large amounts of time and processing resources. The neural network 102 provides increased efficiency by including an internal storage 110. As will be set forth in more detail below, the internal storage 110 greatly enhances the efficiency of the neural network 102 by reducing the number of times that the neural network 102 reads from the external memory 104.

In one embodiment, the feature data 106 is generated by an image sensor (not shown) or another type of sensor of the electronic device 100. Accordingly, the feature data 106 can include image data corresponding to one or more images captured by the image sensor. The image data is formatted so that it can be received by the neural network 102. The neural network 102 analyzes the feature data 106 and generates the prediction data 114. The prediction data 114 indicates a prediction or classification related to one or more aspects of the image data. The prediction data 114 can correspond to recognizing shapes, objects, faces, or other aspects of an image. While some embodiments herein describe that feature data 106 is received from a sensor or sensor system, the feature data 106 can be received from other types of systems or devices without departing from the scope of the present disclosure. For example, the feature data 106 may include a data structure stored in a memory and containing statistical data collected and stored by an external CPU. Other types of feature data 106 can be utilized without departing from the scope of the present disclosure. The components of the neural network 102 may be implemented on a single integrated circuit die as an application specific integrated circuit (ASIC).

While some examples herein describe a neural network 102 implemented in conjunction with an image sensor, the neural network 102 may be implemented in conjunction with other types of sensors without departing from the scope of the present disclosure, or various combinations of types of sensors. Additionally, the neural network 102 may process data other than sensor data without departing from the scope of the present disclosure. Furthermore, machine learning networks or processes other than neural networks can be utilized without departing from the scope of the present disclosure.

In one embodiment, the neural network 102 is trained with a machine learning process to recognize aspects of training images that are provided to the neural network 102. The machine learning process includes passing a plurality of training images with known features to the neural network 102. The machine learning process trains the neural network 102 to generate prediction data that accurately predicts or classifies the features of the training images. The training process can include a deep learning process.

The neural network 102 includes a plurality of hardware accelerators 112. The hardware accelerators correspond to hardware circuits that collectively perform the function of the neural network 102. The hardware accelerators 112 can include convolution units, activation units, pooling units, multiply and accumulate (MAC) units, decompression units, and other types of units.

In the example of a convolutional neural network, the convolution units implement convolution layers of the neural network 102. Accordingly, each convolution unit is the hardware block that implements the convolution operations corresponding to a convolution layer of the neural network 102. Each activation unit is a hardware block that implements an activation operation after the convolution operation. Each pooling unit is a hardware block that implements pooling functions between the convolution layers. The convolution units 106, the activation units 108, and the pooling units 110 cooperate in generating prediction data 114 from the feature data 106.

In one embodiment, each convolution unit is a convolution accelerator. Each convolution unit performs convolution operations on feature data provided to the convolution unit. The feature data is generated from the feature data 106. The convolution operations at a convolution layer convolve the feature data with kernel data generated during the machine learning process for the neural network 102. The convolution operations result in feature data that is changed in accordance with the kernel data.

The data from the convolution unit is provided to an activation unit. The activation unit performs activation operations on the data from the convolution unit. The activation operation can include performing nonlinear operations on data values received from the convolution unit. One example of an activation operation is a rectified linear unit (ReLU) operation. Other types of activation operations can be utilized without departing from the scope of the present disclosure.

The pooling unit receives feature data from the activation unit. The pooling unit performs pooling operations on the feature data received from the activation unit. Pooling operations are performed on the feature data to prepare the feature data for the convolution operations of the next convolution layer. The pooling unit performs the pooling operations between convolution layers. The pooling unit is used to accelerate convolutional neural network operations. The pooling unit can perform max pooling operations, minimum pooling operations, average pooling operations, or other types of pooling operations.

The neural network 102 utilizes tensor data structures for the feature data. The input of each unit hardware accelerator may be an input tensor. The feature data 106 may be stored as a feature tensor. The feature tensor may be provided to the neural network 102 from the external memory 104. The output of each hardware accelerator 112 may be an output tensor with different data values than the input tensor. In one example, the convolution unit receives an input tensor and generates an output tensor. The activation unit receives, as an input tensor, the output tensor of the convolution unit and generates an output tensor. The pooling unit receives, as an input tensor, the output tensor of the activation unit and generates an output tensor. The output tensor of the pooling unit may be passed to the external memory 104.

Tensors are similar to matrices in that they include a plurality of rows and columns with data values in the various data fields. A convolution operation generates an output tensor of the same dimensions as the input tensor, though with different data values. An activation operation generates an output tensor of the same dimensions as the input tensor, though with different data values. A pooling operation generates an output tensor of reduced dimensions compared to the input tensor.

A pooling operation takes a portion, such as a pooling window, of a feature tensor and generates a pooled sub-tensor of reduced dimension compared to the pooling operation. Each data field in the pooled sub-tensor is generated by performing a particular type of mathematical operation on a plurality of data fields (such as taking the maximum value, the minimum value, or the average value from those data fields) from the feature tensor. The pooling operations are performed on each portion of the feature tensor. The various pooling sub-tensors are passed to the next convolution layer as the feature tensor for that convolution layer. Accordingly, pooling helps to reduce and arrange data for the next convolution operation.

Continuing with the example of an image sensor, the image sensor may output sensor data of a plurality of floating-point data values. The floating-point data values may utilize large amounts of memory or may otherwise be unwieldy or inefficient to process with the neural network 102. Accordingly, before the sensor data is arranged into an input tensor, the floating-point data values may undergo a quantization process. The quantization process converts each floating-point data value to a quantized data value. The quantized data value may have reduced numbers of bits compared to the floating-point data values, may be changed to integers, or may otherwise be changed in order to promote efficient processing by the neural network 102.

Various quantization formats can be utilized for the feature data 106. One possible quantization format is a scale/offset format. Another possible quantization format is fixed point format. There may be various advantages to using either of these formats. quantization formats, other quantization formats can be utilized without departing from the scope of the present disclosure.

The stream engine 105 receives the feature data 106 from the external memory 104 and provides the feature data 106 to the stream switch 108. The stream switch 108 is a switch, or series of switches that directs the flow of data within the neural network 102. In general, when data is provided from one component of the neural network 102 to another component, the data passes through the stream switch between the components. Accordingly, a processing chain of the neural network 102 may be set up by configuring the stream switch 104 to provide data between components.

The internal storage 110 is configured to store data received from the external memory 104 so that the external memory 104 can be accessed fewer times. Accordingly, in one example, when feature data is received by the stream engine 105, the stream engine 105 passes the feature data to the internal storage 110 via the stream switch 108. The internal storage 110 then stores the data before the data is provided to a next component of the neural network 102.

In one example, the next component of the neural network may be a hardware accelerator 112 such as a convolution unit. The convolution unit receives the feature data and performs convolution operations by convolving the feature data with kernel data. The kernel data is generated during the machine learning process for the neural network 102. The convolution operations result in feature data that is changed in accordance with the kernel data. The new feature data is provided from one convolution unit 104 a next hardware accelerator 112.

In one example, the kernel data may correspond to a plurality of kernels. Each kernel may have the form of a matrix or tensor of a selected size. Each kernel operates on a portion of the tensor data. Often times, these portions of the tensor data overlap. This could result in reading data multiple times from the external memory 104.

As one example, each kernel may correspond to a 3×3 tensor or matrix. In a convolution sequence, a kernel may operate on a first 3×3 portion (3 columns and 3 rows) of the tensor data. The next kernel (or even the same kernel) may operate on a second 3×3 portion of the tensor data. Kernels may continue to operate on additional 3×3 portions of the tensor data until all of the convolution operations have been performed. The first portion of the tensor data may overlap with the second portion of the tensor data. For example, the second portion of the tensor data may be shifted one column to the right with respect to the first portion of the tensor data such that two columns of the first portion of the sensor data are included. When the final column of the feature data is reached for a group of three rows, the next 3×3 portion may return to the first column and may be shifted downward one row. The shift between the portions may correspond to the stride. Various other schemes for convolving the feature data with kernel data can be utilized. Different kernel sizes can also be utilized.

Due to the overlapping nature of the convolution operations on the feature data 106 with various kernels, individual data values from the feature data 106 may be provided to the convolution accelerator many times. One possible solution is to read these individual data values multiple times from the external memory 104. However, this is both time-consuming and resource intensive. Accordingly, reading each data value of the feature data 106 from the external memory 104 multiple times can lead to serious drawbacks that in terms of the effectiveness and efficiency of the neural network 102.

The neural network 102 avoids the drawbacks of reading the same data multiple times from the external memory 104 by implementing the external storage 110 within the neural network 102. In particular, the feature data 106 may be provided in relatively large batches from the external memory 104 to the neural network 102. The stream engine 105 provides the batch of feature data to the internal storage 110 via the stream switch 105. The next hardware accelerator 112 (e.g., a convolution accelerator) can then receive the feature data 106 from the internal storage 110. Instead of reading the data values multiple times from the external memory 104, the hardware accelerator 112 can read data values from the internal storage 110. This can greatly reduce the number of times that the external memory 104 is accessed.

In one embodiment, the internal storage 110 not only stores feature data before providing the feature data to the hardware accelerator 112, the internal storage 110 also rearranges the data when storing the data. For example, the internal storage 110 may include transformation and control circuitry that stores the feature data 106 with a write addressing pattern selected to promote the efficiency and providing the data to the next hardware accelerator 112. Rather than writing the data values sequentially in rows and columns of a memory array of the internal storage 110 in the order they are received from the external memory 104, the transformation and control circuitry of the internal storage 110 may store the data values in a nonsequential manner in the rows and columns of the memory array relative to the order in which they are received from the external memory 104. The write addressing pattern is selected based on how data is processed by the next hardware accelerator 112. This can greatly enhance the efficiency and providing data to the hardware accelerator 112 from the internal storage 110.

In one embodiment, the transformation and control circuitry of the internal storage 110 may also read the feature data out to the next hardware accelerator 112 in accordance with a selected read address pattern. Rather than reading the data from rows and columns of a memory array of the internal storage 110 sequentially, the transformation and control circuitry of the internal storage 110 may read data values from the rows and columns of the memory array of the internal storage 110 in a nonsequential manner. The read addressing pattern can be selected based on how data is processed by the next hardware accelerator 112. Reading the data in this manner can greatly enhance the efficiency in providing data to the hardware accelerator 112 from the internal storage 110. As used herein, reading data with the internal storage 110 corresponds to outputting data from the internal storage 110 to another component of the neural network 102.

The rearrangement of the data via selective writing patterns and reading patterns can greatly enhance the efficiency of the neural network 102. In particular, the feature data can be provided to the hardware accelerator 112 with a pattern that enables rapid access and processing of the feature data. Continuing again with the example of a convolution operator, the feature data can be read in a manner selected to enable convolution operations with kernel data with great efficiency.

The internal storage 110 can operate as a smart cache. In particular, the transformation and control circuitry of the internal storage 110 can include a write transformer unit, a read transformer unit, and a control unit. These units can write data and read data with selected writing and reading address patterns to promote the efficiency of the neural network 112.

As used herein, the term “convolution unit” can be used interchangeably with “convolution circuit” or “convolution circuitry”. As used herein, the term “pooling unit” can be used interchangeably with “pooling circuit” or “pooling circuitry”. As used herein, the term “activation unit” can be used interchangeably with “activation circuit” or “activation circuitry”. As used herein, the term “requantization unit” can be used interchangeably with “requantization circuit” or “requantization circuitry”. This is because convolution units, the activation units, the pooling units, and the requantization units 112 are hardware circuits.

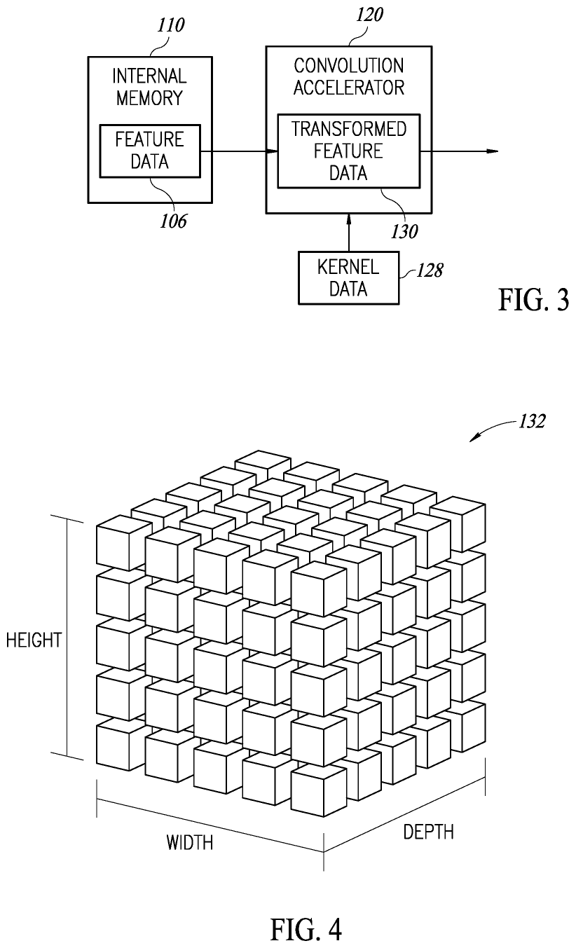

FIG. 2 is a functional flow diagram of a process 200 that can be utilized by a neural network 102, according to one embodiment. At 202, data is read from an external memory 104 via a stream engine 105 (not shown, see FIG. 1) and provided to the internal storage 110 via a stream switch 108 (not shown, see FIG. 1). At 204, the internal storage 110 writes the data with a write addressing pattern selected to enhance the efficiency of the neural network 102. At 204, internal storage 110 then reads (outputs) the data to a convolution accelerator 120 in accordance with a read address pattern selected to promote the efficiency of the neural network 102. The convolution accelerator 120 processes the feature data and provides the processed feature data to the pooling unit 122 via the stream switch. At 206, the pooling unit 122 performs pooling operations on the processed feature data. At 208, the pooling unit 110 provides the processed feature data to the external memory 104 via a stream engine 105 and a stream switch 108. The operation of the convolution accelerator 120 and the pooling unit 122 may correspond to a single layer of a CNN.

At 210, the processed feature data is read from the external memory into the internal storage 110 via the stream switch 108 and the stream engine 105, as described previously. The internal storage 110 may write the processed feature data to memory with an address pattern selected to promote the efficiency of the neural network 102. At 212, the internal storage 110 may read the processed feature data to a convolution accelerator 120 with a read pattern selected to promote the efficiency of the neural network 102. The convolution accelerator 120 processes the feature data. At 214 convolution accelerator 120 provides the now doubly processed feature data to the pooling unit 122 via the stream switch. The pooling unit 122 performs pooling operations on the feature data. The operations of convolution and pooling may correspond to a second convolution layer of the neural network.

The pooling unit 110 may provide the processed feature data to the fully connected layers. The fully connected layers may then output prediction data 114. Although only the convolution accelerator 120 and the pooling unit 122 are shown as hardware operators in the process 200, in practice, other hardware accelerators may be utilized instead of or in addition to the convolution accelerator 120 and the pooling unit 122. Additional convolution layers may also be utilized prior to passing data to the fully connected layers.

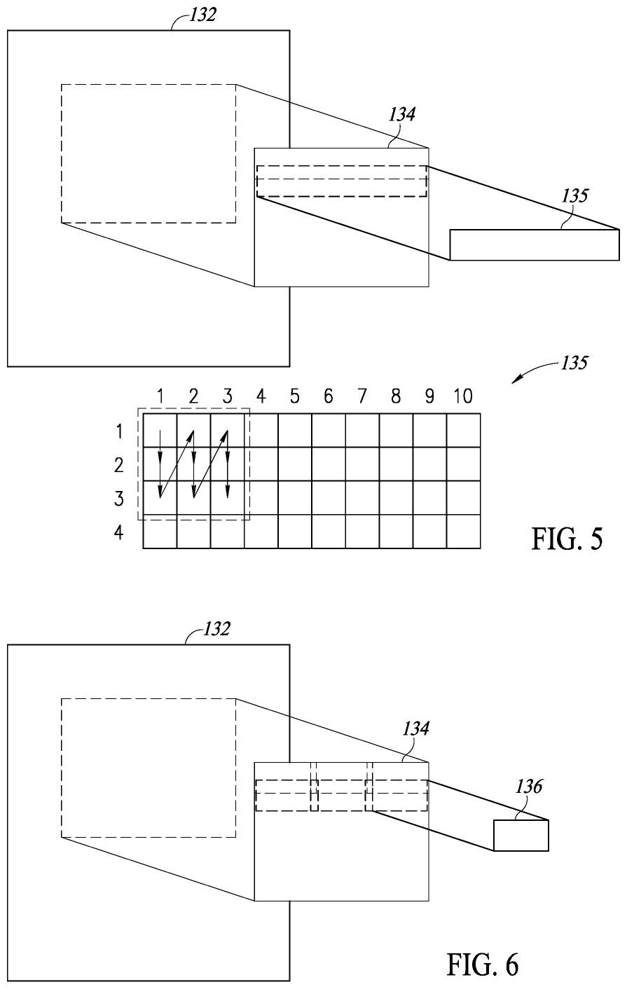

FIG. 3 illustrates a portion of a neural network 102, in accordance with some embodiments. Feature data 106 has been stored in the internal memory 110. The feature data 106 can be written to the internal memory 110 with a selected write addressing pattern. The feature data 106 can then be read to a convolution accelerator 120 with a selected read address pattern. The convolution accelerator 120 generates transformed feature data 130 (or processed feature data) by convolving the feature data 106 with kernel data 128. The reading of the feature data 106 to the convolution accelerator 120 is selected to enable the convolution accelerator 120 to perform a series of convolution operators with kernels from the kernel data 128 in a very efficient manner.

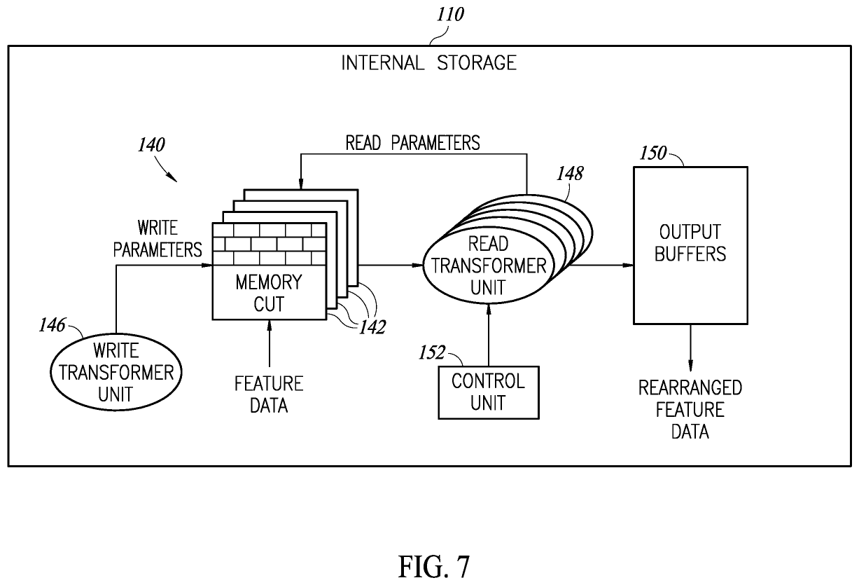

FIG. 4 is a representation of a feature tensor 132, according to one embodiment. The feature tensor 132 includes a plurality of blocks. Each of these blocks represents a data value. The tensor 132 includes height, width, and depth. While the feature tensor 132 of FIG. 4 illustrates a 5×5×5 tensor, in practice, the feature tensor 132 may include other height, width, and depth dimensions.

In one embodiment, during the various convolution, activation, pooling, and requantization operations, the feature tensor 132 is divided into batches. The feature tensor 132 may be batched by height, width, or depth. Convolution, activation, pooling, and requantization operations are performed on the batches from the feature tensor. Each batch may be considered a sub-tensor of the feature tensor 132.

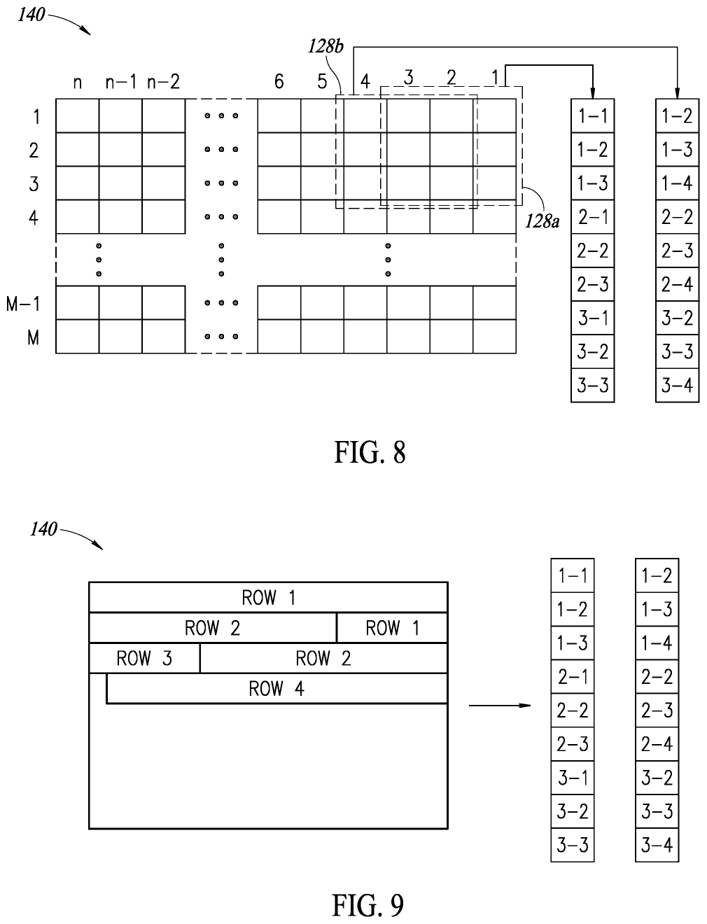

FIG. 5 illustrates a tensor 132 in accordance with one embodiment. In practice, the tensor 132 is read in batches 134 into the neural network 102. The batch 134 is stored in the internal storage 110. The batch 134 may then be read from the internal memory 110 in stripes 135. In the example of FIG. 5, the stripe has four rows and 10 columns. The number of columns of the stripe is the same as the number of columns of the batch 134. In practice, stripes 134 can have different dimensions or configurations without departing from the scope of the present disclosure.

FIG. 5 also illustrates a manner in which the stripe 135 may be read to the convolution unit 120. In particular, the stripe may be read from the internal storage 110 in columns, returning to the top after reading the bottom of the column. In the example FIG. 5, the dashed lines of the stripe illustrate a 3×3 portion of the tensor data that may be convolved with a 3×3 kernel by the convolution accelerator. A next 3×3 portion to be convolved with a next kernel may have a stride of one column to the right. Reading the data out of the internal storage 110 by columns in the manner shown can greatly improve the efficiency of the convolution operations with the kernels.

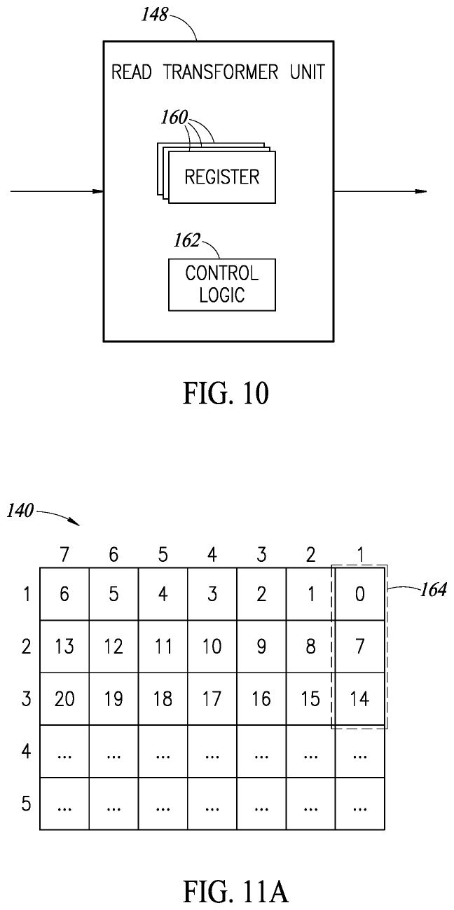

FIG. 6 illustrates a tensor 132 in accordance with one embodiment. In practice, the tensor 132 is read in batches 134 into the neural network 102. The batch 134 is stored in the internal storage 110. The batch 134 may then be read from the internal memory 110 in patches 136. Each patch may have a number of columns less than the number of columns in the batch 134.

FIG. 6 illustrates, via the dashed boxes, how a plurality of overlapping patches 136 may be drawn from a batch 134. The reading pattern of the data value of the patches 136 may be selected to help ensure efficient convolution operations with kernels of a convolution accelerator.

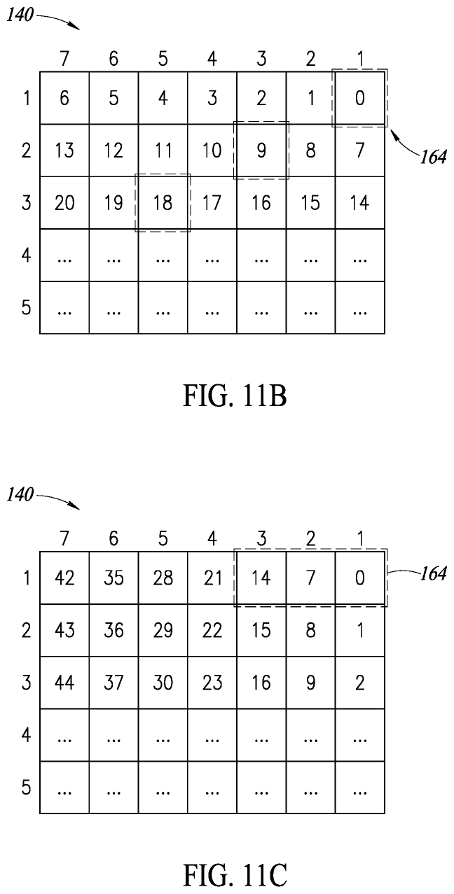

FIG. 7 is a block diagram of the internal storage 110, in accordance with some embodiments. The internal storage 110 includes a memory array 140. The memory array 140 may be arranged in rows and columns of memory cells. The memory array 140 may be divided into a plurality of memory cuts 142. Each memory cut 142 may have its own write ports and read ports. In one embodiment, each memory cut 142 may be associated with a particular hardware accelerator 112 of the neural network 102. In one embodiment, multiple cuts may be associated with a single hardware accelerator 112. Each memory cut 142 may include a plurality of memory cells arranged in rows and columns. The internal storage 110 may include logic around the memory array 140 such as pointers, enablers, etc.

In one embodiment, the memory array 140 is a static random-access memory (SRAM) array. Other types of memory can be utilized in the memory array 140 without departing from the scope of the present disclosure. One example, the memory array 140 is 1024×120 memory cells, corresponding to 16 kB, though other sizes can be utilized without departing from the scope of the present disclosure.

The internal storage 110 includes a write transformer unit 146. When data is passed to the internal storage 110, the write transformer unit 146 may write the feature data into the memory 140 in accordance with a write address pattern selected to enable efficient operation on the feature data by a next hardware accelerator 112. The internal storage 110 may include configuration registers that control the function of the write transformer unit 146.

The internal storage 110 includes a read transformer unit 148 and a control unit 152. The control unit 152 controls the operation of the read transformer units 148. The read transformer unit reads data from the memory 140 in accordance with read parameters. The read parameters are provided by the control unit 152. The read parameters are selected as a pattern of addresses by which data will be read from the memory 140 to the output buffers 150. The feature data can be passed as rearranged feature data from the output buffers 150 of the internal storage 110 to a hardware accelerator 112.

The read transformer unit 148 may work with multiple memory cuts 142. This can allow having both more data to be served to the following hardware accelerators 112 and to dedicate different memory cuts 142 to different hardware accelerators 112. The solution can consider a selection method among the different memory cuts 142, choosing which one to address to retrieve the following data given the unit to which the data is to be sent. The memory cuts 142 can have the same or different numbers of rows and columns. The read transformer unit 148 can use each of the memory cuts 142 by knowing their sizes.

The control unit 152 may work as an interface between the memory 140 and the read transformer unit 148. The control unit may generate write addresses, read addresses, and may determine that the minimum amount of data has been received to begin reading data out to the next hardware accelerator 112. The control unit may take into account dimensions of the tensor in the dimensions of stripes and patches.

In one embodiment, once a selected minimum amount of data has been written to the memory 140, the read transformer unit 148 can begin to read data to a next hardware accelerator 112. Data can be reorganized while reading the data due to the selected read addressing pattern utilized by the read transformer unit 148.

In one embodiment, the write transformer unit 146 can transform feature data 146 and can make the feature data suitable to be written in the memory 140. For example, if each data value of the feature data is 32 bits, the write transformer unit 146 may reduce the number of bits in each data value to 24 bits by discarding eight bits from each data value.

The internal storage 110 may be utilized in connection with convolutional neural network architectures in order to correctly arrange, reorganize and transform the data to reduce the execution time and exploit data usage in this kind of application. However, the internal storage 110 is not limited to this framework and could be used in every architecture which performs the management of data and its manipulation in order to simplify the computations.

The internal storage 110 may be primarily (but not only) utilized to prepare the data for the following operations in order to have them ready to be fed to a hardware accelerator. The reorganization of data may follow methodologies capable of exploiting data locality or data organization to obtain faster and more compact operations, hence reducing execution times, number of epochs in the computation and overall energy consumption.

In one embodiment, the data arrive in packets of n bits, specified by the architecture connections and could be then packed, reorganized and transformed to obtain the benefits described herein. The local storage 110 provides operation modes dedicated to obtaining a solution for memory efficiency problems and to provide the management among the different memory units in order to coordinate them and correctly format the data to be processed by the different units of the architecture and optimize its energy consumption over the entire computation.

The internal storage 110 may utilize nested loop processes for convolutional neural networks. In this scenario the internal storage may exploit hardware and software approaches for im2col, im2row transforms and in general re-layout strategies for the input tensor to obtain better data utilization. Data may first be organized offline by a compiler in a way that some advantage could be exploited from the way the data are stored and/or retrieved. This may provide easier memory access (both for storage and retrieval of the data) and/or easier organization and development of the calculations needed (for convolutions or other types of operations).

The internal storage 110 may utilize the write transformer unit 146 and the read transformer unit 148 to correctly write/read to/from the memory unit. These units may be utilized to according to the indication given by the compiler, since in this way it would be possible to store and retrieve the data not only from a time perspective, but also from spatial one (both for the kernels and the features). The reading and the writing processes may utilize a nested loops approach, exploiting several parameters to organize the read/write of the data.

This hardware solution may also follow this kind of approach considering several parameters in the memory management and exploiting them to provide both efficiency and flexibility through different memory operations, in order to correctly exploit the advantages given from the data reshaped by the compiler. Memory ports could be single or multiple, given the number of units sharing the memory itself in the design. In the former case every unit could have its own dedicated memory cut 142. In the latter case more management of the memory could be utilized but higher flexibility of the same could be considered and sub partitions of it could be considered at the start of a new epoch.

Read and write operations can also follow a certain scheduling and provide some synchronization, handshaking or/and granting mechanism to correctly provide the data transformation and output the correct data avoiding issues. Therefore, also the memory cuts 142 can be aligned to the hardware units needs and hence to the elaboration ones providing a scheduler for the contemporary access to the memory of more than one unit, while using a shared memory approach.

Moreover, the definition of the size and dimensions of the different memory cuts 142 may be designed and specified in order to be able to manage the transformed data and to store and provide it for the different nested loop solution approaches in order to make the unit reusable for different neural network models. The design may also provide some customized memory cuts for specialized operations in the case of using convolutional neural network models that use well-known read/write patterns. The design of the internal storage 110 may also provide smart addressing modes to correctly address multiple cuts of memory at the same time, just on the addressing pattern, data or both, being also capable of reducing the time and the energy to develop the operations for the different units.

Further details regarding neural networks and machine learning applications can be found in T. Chen, Z. Du, N. Sun, J. Wang, C. Wu, Y. Chen, and O. Temam, “DianNao: a small-footprint high-throughput accelerator for ubiquitous machine-learning,” in Proc. 19th Int'l Conf. on Architectural Support for Programming Languages and Operating Systems. ACM, 2014, pp. 269-284, Y. Chen, T. Luo, S. Liu, S. Zhang, L. He, J. Wang, L. Li, T. Chen, Z. Xu, N. Sun et al., “DaDianNao: a machine-learning supercomputer,” in 47th Annual IEEE/ACM Int'l Symp. on Microarchitecture (MICRO), IEEE, 2014, pp. 609-622, M. Peemen, A. A. Setio, B. Mesman, and H. Corporaal, “Memorycentric accelerator design for convolutional neural networks,” in 31^{st} Int'l Conf. on Computer Design (ICCD) IEEE, 2013, pp. 13-19, and J. Jin, V. Gokhale, A. Dundar, B. Krishnamurthy, B. Martini, and E. Culurciello, “An efficient implementation of deep convolutional neural networks on a mobile coprocessor,” in IEEE 57th Int'l Midwest Symp. on Circuits and Systems (MWSCAS), IEEE, 2014, pp. 133-136, each of which is incorporated herein by reference in their entireties.

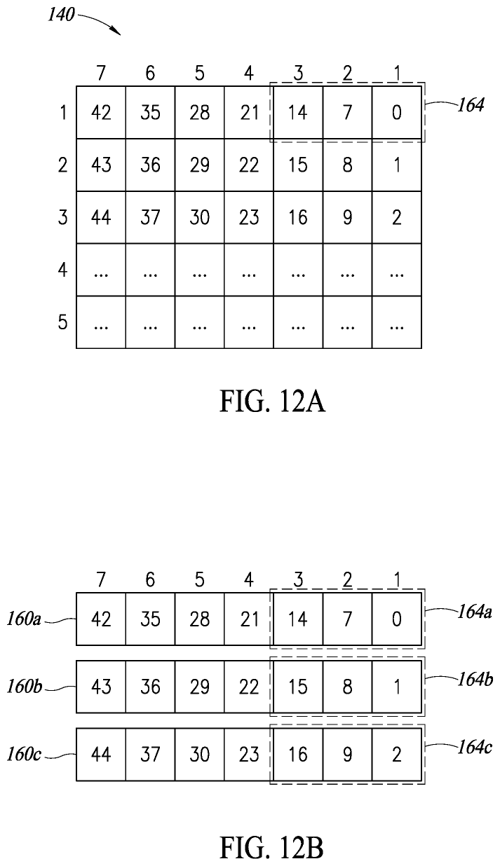

FIG. 8 is an illustration of a memory 140 of an internal storage 110 of a neural network 102, according to one embodiment. The memory 140 of FIG. 8 is one example of a memory 140 of FIG. 7. The memory 140 is arranged in n rows and m columns.

FIG. 8 also illustrates the portion of data on which a first kernel 128a will operate when the data is passed to a convolution operator. The internal storage 110 reads out the data corresponding to the first kernel 128a in columns in order to facilitate convolution operation of the kernel 128a on the selected portion of the feature data in the memory 140, in one embodiment. The first portion includes data from rows 1, 2, 3 and from columns 1, 2, 3.

In one embodiment, the data for the first kernel 128a is written to the output buffer of the internal storage 120 by rows in which the data values of the first row (1-1, 1-2, and 1-3) are first read, then the data values in the second row (2-1, 2-2, and 2-3) are read, and finally the data values of the third row (3-1, 3-2, and 3-3) are read. This reading pattern may greatly facilitate convolution operations to be performed in accordance with the kernels of the kernel data. Other reading patterns can be utilized without departing from the scope of the present disclosure.

FIG. 8 also illustrates the portion of data on which a second kernel 128b will operate when the data is passed to a convolution operator. In one embodiment, the internal storage 110 reads out the data corresponding to the first kernel 128b in rows in order to facilitate convolution operation of the kernel 128b on the selected portion of the feature data in the memory 140. For example, the data to be convolved with the second kernel 128b are read by rows in which the data values of the first row (1-2, 1-3, and 1-4) are first read, then the data values in the second row (2-2, 2-3, and 2-4) are read, and finally the data values of the third row (3-2, 3-3, and 3-4) are read. This reading pattern may greatly facilitate convolution operations to be performed in accordance with the kernels of the kernel data. Other reading patterns can be utilized without departing from the scope of the present disclosure as can be seen, sixth data values to be convolved with the first kernel 128a overlap with the data values to be convolved with the second kernel 128b. Because the data are initially stored in the internal storage 110, the repeated data values can be read from the internal storage 110 rather than repeatedly accessing the external storage 104.

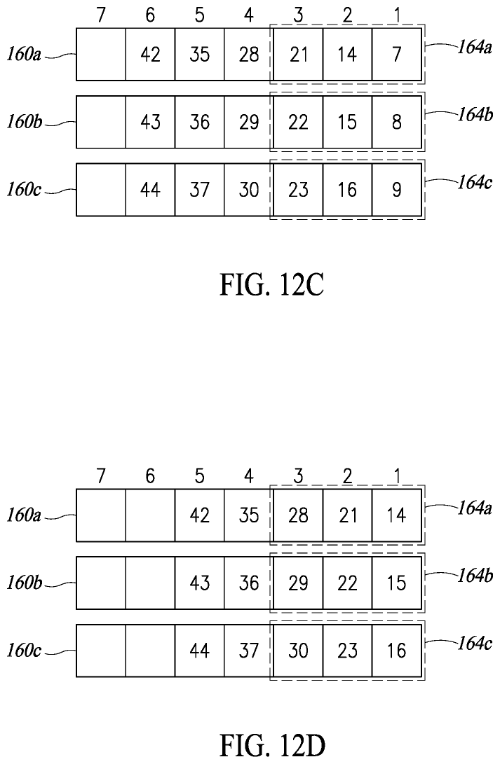

FIG. 9 is an illustration of a memory 140 of an internal storage 110 of a neural network 102, according to one embodiment. FIG. 9 illustrates how rows of tensor data may be larger than rows of the memory 140. Accordingly, a single row of tensor data may occupy portions of two rows in the memory 140. The write transformer unit 146 and the read transformer unit 148 can help ensure that when data is read from the memory 140 to the convolution operator 120, the addresses are selected to ensure that the data is read in a manner that facilitates convolution operations with the kernels.

The internal storage 110 can determine when a next data value to be convolved with a next kernel is found in a same row of the physical memory of the memory array 140 or in a different row of physical memory of the memory array 140. Accordingly, the writing and reading of data can be accomplished with patterns of physical addresses that promote the efficiency and providing the data to a next hardware accelerator 112.

In one embodiment, in accordance with the example shown in FIG. 9, for a first patch (to be convolved with a first kernel) the internal storage 110 reads the first three data values (1-1, 1-2, and 1-3) of the first row of the tensor data, then the first three data values (2-1, 2-2, and 2-3) of the second row of the tensor data, then the first three data values (3-1, 3-2, and 3-3) of the of the tensor data. Because the rows of the tensor data are different than the physical rows of the memory 140 of the internal storage, the internal storage intelligently reads the correct sequence of data values in spite of the difference in size of rows between the original tensor data and the memory array 140. After reading the first patch, a second patch can be read by shifting to the right one column of tensor data.

Accordingly, the internal storage may pay particular attention when picking data for the same row over different lines (address increase +1, with possibly no increase when shifting to the next row). Knowing the row and column offsets, the internal storage 110 can intelligently know when to change the address when shifting from one pixel to another one change the address when shifting from one pixel to a “contiguous” one.

Knowing the height offset the internal storage 110 can know how many locations to skip before the next data when changing row in the considered patch, together with the vertical stride Hstride. These parameters may also help, combined with the horizontal stride Wstride and Hstride to move the vertical and horizontal pointers of the memory to the starting point of the next patch to be considered.

The internal storage 110 implements a scheme tackling the issue from both a software aspect and an ASIC hardware aspect. This is fit to be used for different neural network models in a programmable fashion, in order to obtain solutions for the different needs in the different scenarios. This may also improve power performance and overall computation speed for ASIC implementations.

Embodiments of the present disclosure implement the scheme for tackling neural network throughput issues from both a software and an ASIC hardware aspect. Embodiments of the present disclosure are fit to be used with different CNN models in a programmable fashion in order to obtain solutions for different needs in different scenarios. Embodiments of the present disclosure are programmable and are fit to be used for different CNN models to improve power performances and overall computation speed for ASIC implementations. Embodiments of the present disclosure provide multiple solutions for output stages for a reconfiguration in local storage unit. This allows to obtain different trade-offs in different scenarios in order to achieve better throughputs and performances.

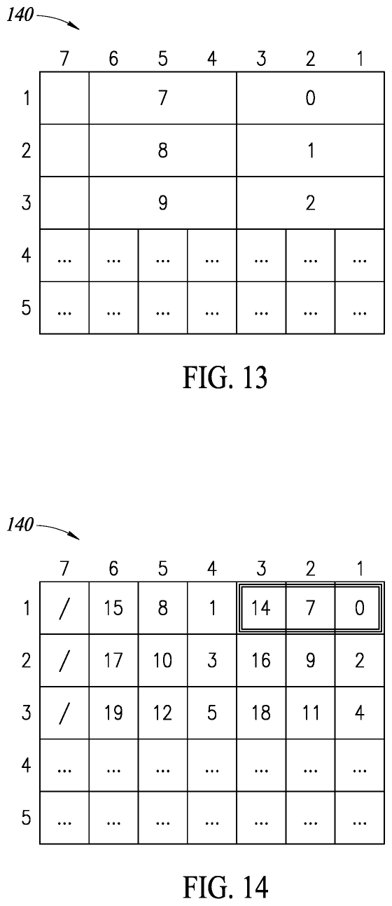

FIG. 10 is a block diagram of a read transformer unit 148, in accordance with one embodiment. The read transformer unit 148 of FIG. 10 is one example of a read transformer unit 148 of FIG. 7. Accordingly, the read transformer unit 148 is part of an internal storage 110, as described in relation to FIGS. 1-9.

The read transformer unit 148 includes a plurality of registers 160 and control logic 162. As described previously, the read transformer unit 148 reads data from the memory 140 in accordance with read parameters. The read parameters are provided by the control unit 152. The read parameters are selected as a pattern of addresses by which data will be read from the memory 140 to the output buffers 150. The feature data can be passed as rearranged feature data from the output buffers 150 of the internal storage 110 to a hardware accelerator 112.

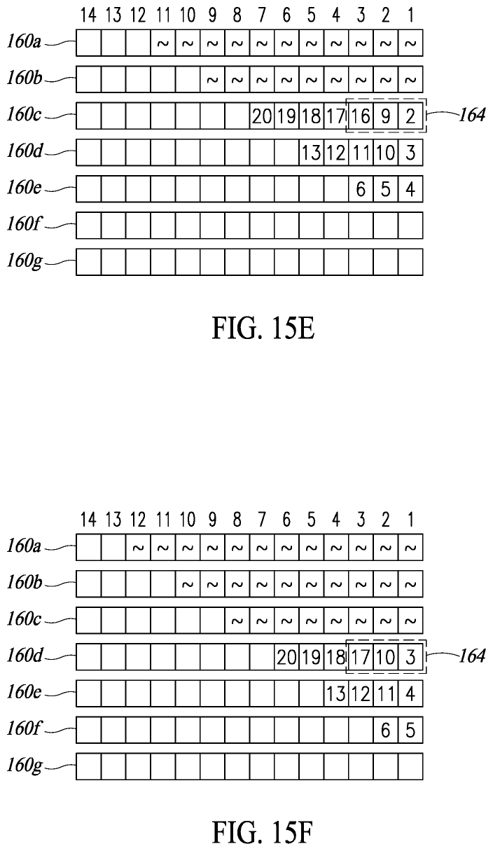

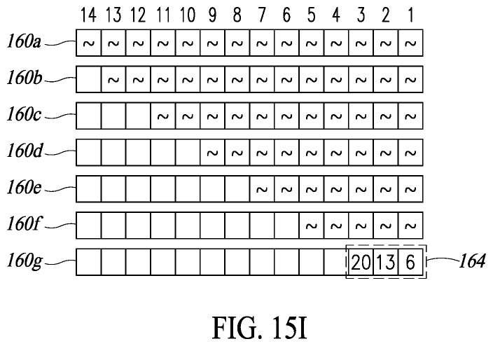

In one embodiment, the read transformer unit 148 utilizes the registers 160 to enable efficient reading of data from the memory 140 of the internal storage 110 to the output buffers 150. When the read transformer unit 148 reads data from the memory 140, the read transformer unit 148 can load the data into the registers 160 in a selected manner so that data can be read fewer times from the memory 140, resulting in increased efficiency. The control logic 162 can assist in the reading of data from the memory 140 into the registers 160 and passing data from the registers 160 to the output buffers 150. The read transformer unit may also include a plurality of counters and other circuitry. The control logic 162 may be part of the control unit 150 20 may be separate from the control unit 152. Further details regarding usage of the registers 160 are provided in relation to FIGS. 13A-13D and 15A-15I.

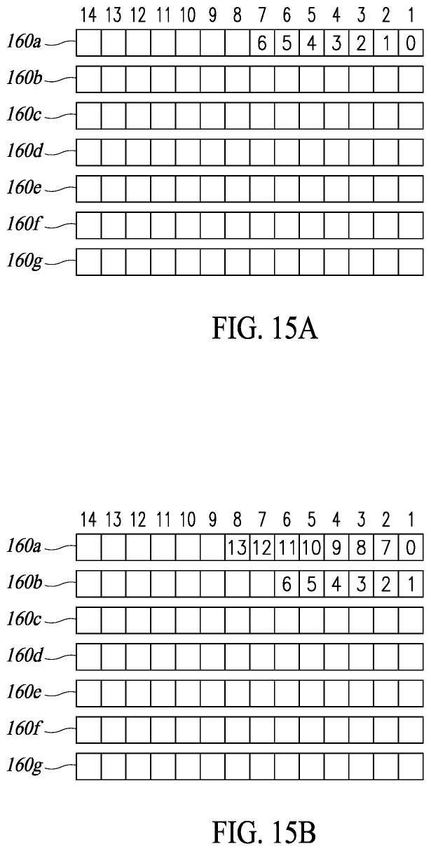

FIGS. 11A-11C are illustrations of a memory 140 of an internal storage 110, in accordance with one embodiment. FIG. 11A illustrates a scenario in which a tensor (or a portion of a tensor) from which data is read into the memory 140 of the internal storage 110 has a same width as the memory 140. FIG. 11B illustrates a scenario in which a tensor (or portion of a tensor) from which data is read into the memory 140 has a different width than the memory 140. FIG. 11C illustrates principles by which data that is read from a tensor can be transformed by a write transformer unit 146 of the internal storage 110 to facilitate efficient reading of data from the memory 140 regardless of differences between the width of the memory 140 and the input tensor, in accordance with one embodiment.

In FIG. 11A, the memory 140 has a width of seven (i.e., seven columns). The input tensor from which data is read into the memory 140 also has a width of seven. In the example of FIG. 11A, the kernel has a height of three. Accordingly, the data to be convolved with kernel may be made up of vectors 164 with three data values. The data values of interest are described as vectors, but in practice, each vector corresponds to a portion of a column of tensor data. In the example of a kernel height of three, each vector corresponds to three data values from a particular column of tensor data. As a simple example, if the first vector 164 is to have the first data value from each row of the tensor data, then the vector 164 can be conveniently read as the first data value from each of the first three rows of the memory 140 (here, values 0, 7, and 14). A next vector 164 to be retrieved may include the second data value from each of the first three rows (here, values 1, 8, and 15), and so forth. These operations may be somewhat simple because the width of the memory 140 is the same as the width of the tensor. While these read operations are described as vectors 164, in practice, a patch of data may be read for each kernel including multiple vectors.

In FIG. 11B, the memory 140 has a width of seven, but the input tensor has a width of nine. Accordingly, a first vector 164 to be read from the memory 140 would include the data values 0, 9, and 18. Such a read operation is less convenient because rather than reading the first data value from each of the first three rows for the first vector 164, the first vector 164 includes the first value 0 from the first row, the third value 9 from the second row, and the fifth value 18 from the third row. This is significantly less convenient and may become increasingly inefficient with subsequent read operations.

In the examples of FIGS. 11A and 11B, three rows are read from the memory 140 of the internal storage 110 in order to obtain the three values for a vector 164. This corresponds to three separate read operations. With each read operation, many bits may be read, but only a fraction of them are used. Moreover, in subsequent operations the same locations may be read over and over, with resultant inefficient memory use. The effect is more severe with small strides and hence fewer bits of the word dedicated to each pixel.

FIG. 11C illustrates a reading scheme, in accordance with one embodiment. In FIG. 11C, and ordering fit for a better column retrieval is provided. More particularly, when feature data (tensor data) is received at the internal storage 110, the write transformer unit 146 provides write parameters for writing the feature data into the memory 140 for easy column retrieval. As can be seen in FIG. 11C, data values 0, 7, and 14 from the tensor data are written into the first three slots of the first row of the memory 140. Accordingly, the first vector 164 to be read now occupies the first three slots of the first row of the memory 140. This enables the vector to be read with a single row read operation. The next vector 164 to be read, including data values 1, 8, and 15, is in the first three slots of the second row. This enables the next vector column to be read in a single read operation of the second row. The next vector, including data values 2, 9, and 16 is in the first three slots of the third row.

When the first three slots of each row include a vector, the next vector or column is written to the next three slots of the first row of the memory 140. In the example of FIG. 11C, this corresponds to data values 21, 28, 35, in the example of FIG. 11C. The next three slots of each row are then filled with data values in the same manner.

In this way, it is possible to read all of a column of tensor data (here described as a vector) in a same read operation. The next read operation will be performed on another memory address related to the following column. The efficiency of the read operation is better than in FIGS. 11A and 11B. However, the same locations may be read several times when shifting the window. Nevertheless, the solution resolves some of the aforementioned drawbacks. In particular, the issue shifted on the writing operations since an initial treatment of each pixel is utilized in input. When the window to be considered is written across more than one memory location (i.e., across more than one row), more read operations may be needed, such as when a column of interest occupies portions of two rows of the memory 140. The solution corresponds to line writing alignment with shifting.

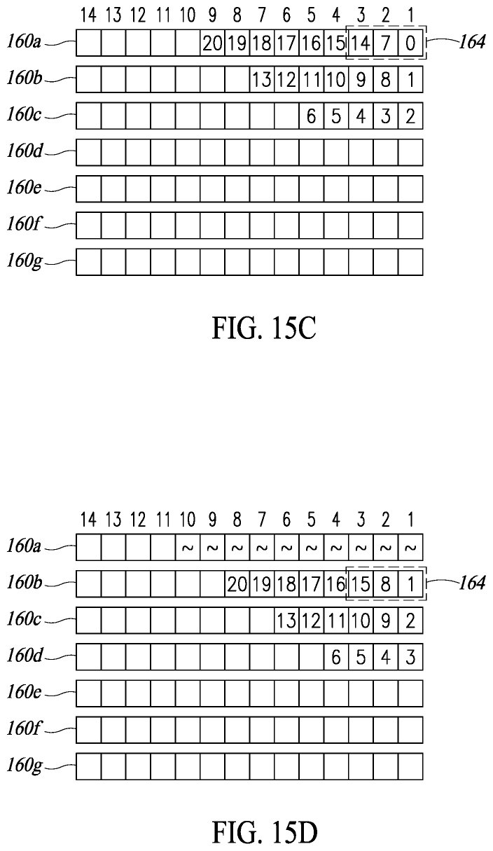

FIGS. 12A-12D illustrate a scheme that can improve on issues associated with the scheme described in relation to FIG. 11C, in accordance with one embodiment. In particular, the scheme of FIGS. 12A-12D utilizes the registers 160 of the read transformer unit 148, as described in relation to FIG. 10. In FIG. 12A, tensor or feature data has been written to the memory 140 substantially as described in relation to FIG. 11C.

In FIG. 12B, three registers 160a-c are utilized. Data from the first row of the memory 140 is read into the register 160a. Data from the second row of the memory 140 is read into register 160b. Data from the third row of the memory 140 is read into the register 160c. A first vector or set of data values 164a is then passed from the first three slots of the register 160a on a first clock cycle. A second vector or set of data values 164b is read from the first three slots of the register 160b on a second clock cycle. A third vector or set of data values 164c is read from the third register 160c on a third clock cycle. Each vector 164 is read in a single read operation as the first three values in the register 160.

In FIG. 12C, each of the registers 160a-c has shifted one data value to the right. In a next clock cycle, a vector 164a (including data value 7, 14, and 21) is read from the register 160a. A second vector or set of data values 164b (including data values 8, 15, and 22) is read from the first three slots of the register 160b on a next clock cycle. A third vector or set of data values 164c (including data values 9, 16, and 23) is read from the third register 160c a next clock cycle.

In FIG. 12D, each of the registers 160a-c has shifted one data value to the right. In a next clock cycle, a vector 164a (including data value 14, 21, and 28) is read from the register 160a. A second vector or set of data values 164b (including data values 15, 22, and 29) is read from the first three slots of the register 160b on a next clock cycle. A third vector or set of data values 164c (including data values 16, 23, and 30) is read from the third register 160c a next clock cycle. This scheme corresponds to column writing alignment and column reading.

In the example of FIGS. 12A-12D, there is a horizontal stride of 1. In other words, only a single data value is shifted in each register between sets of read operations. The result is that each data value may be read multiple times. However, in other examples, a stride of two or three may be utilized in which two or three data values is shifted. If all three data values are shifted, then no data value is read twice.

FIGS. 12A-12D illustrates three registers. However, in practice, it may be beneficial to have a register for each row of the memory 140. This can possibly cause an issue if there is a large number of rows in the memory 140 as this will result in the use of a large number of registers 160.

FIG. 13 illustrates a reading scheme, in accordance with one embodiment. In the case of vertical strides larger than 1, it would be possible to exploit this kind of parameter with various storage schemes. FIG. 13 illustrates an example for vertical stride of 2. In this case, it is possible to store just the pixels of the columns to be considered in one memory location. This allows to improve the efficiency of the reading operations given that the reading instructions would follow the spatial configuration of the data in the memory. Even if the memory locations are not entirely written in most of the cases, the trade-off is advantageous in some configurations given that this inefficiency is counterbalanced by the possibility of reading data just one time. However, these considerations may be limited to cases of certain strides in pixel dimensions. Accordingly, this can result in a high degree of constraint by the parameters. The scheme corresponds to a line writing alignment scheme with shifters and parallel repacking.

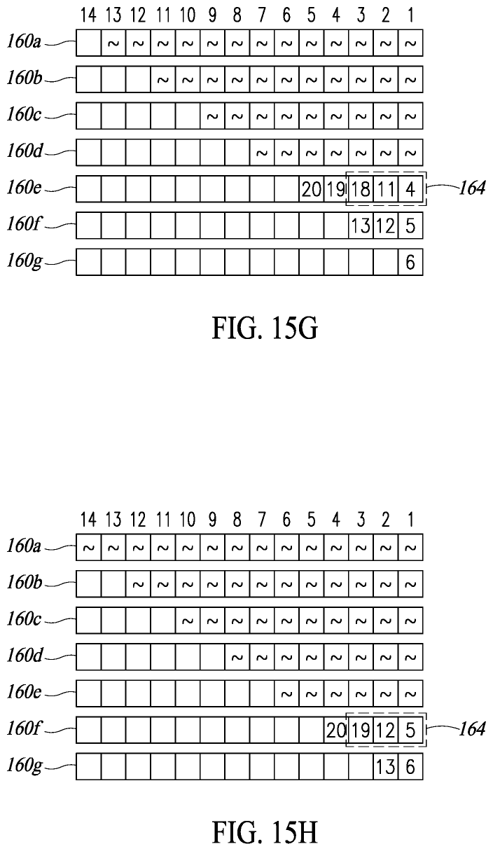

FIG. 14 illustrates a reading scheme of a vertical stride of three with two columns stored in a memory location (row), in accordance with one embodiment. In this case, each row of the memory 140 includes two columns from the tensor data. The first row includes a first column of the feature data including data values 0, 7, and 14. The first row includes a second column of the feature data including data values 1, 8, and 15. Remaining storage slots of the row are blank. The second neural includes a second column the feature data including data values 2, 9, 16. The second row includes a second column of the feature data including data values 3, 10, and 17. The third row includes a first column of the feature data including data values 4, 11, and 18. The third row includes a second column the feature data including data values 5, 12, and 19.

Similar considerations apply for cases in which different vertical strides are considered and it is possible to fit one or more columns inside a single memory location (i.e., a row). Having larger vertical strides with smaller pixels would also result in the case of storing more than one column per memory location in a different writing scheme in this case, it would be possible to write more than one pixel per time. This reduces the number of writings per single transaction and obtains the memory configurations displayed in FIG. 14.

FIGS. 15A-15I illustrate a reading scheme that utilizes a plurality of registers 160 of a read transformer unit 148, in accordance with one embodiment. As will be set forth in more detail below, after a set up period corresponding to a number of clock cycles equal to the number of data values in a column or vector 164, a vector 164 can then be read on each subsequent clock cycle without retrieving a data value multiple times from the memory 140. This can correspond to a line writing alignment with pipeline shifters for column wise outputs. In FIGS. 15-15I, seven registers 160a-106g are illustrated. However, other numbers of registers can be utilized without departing from the scope of the present disclosure.

In FIG. 15A, the first seven data values (data values 0-6) are read from the memory 140 into the first seven slots of the register 160a in a first clock cycle. In FIG. 15B, the next seven data values (data values 7-13) are read from the memory 140 into slots 2-7 of the register 160a in a second clock cycle. The first lot of the register 160a is not overwritten in the second clock cycle. In the second clock cycle, data values 1-6 are passed from the register 160a to the register 160b.

In FIG. 15C, the next seven data values (numerals 14-20) from the memory 140 are read into slots 3-9 the register 160a in the third clock cycle. The memory slots 1 and 2 of the register 160a are not overwritten in the third clock cycle. As can be seen, data values 0, 7, and 14 now occupied the first three slots of the register 160a. This corresponds to a first vector 164 for convolution with the kernel data. As will be set forth in more detail below, in each subsequent clock cycle, another vector 164 will be ready for reading from a next register. In the third clock cycle, data values 8-13 are passed from the first register 160a to slots 2-7 of the register 160b, without overwriting the first lot of the register 160b. Furthermore, data values 2-6 are passed from the register 160b to the register 160c in the third clock cycle.

In FIG. 15D, on the fourth clock cycle the next seven data values are read from the memory 140 into the register 160a (not shown explicitly). The data values 15-20 are passed from the register 168 to the register 160b, without overwriting slots 1 and 2 (including data values 1 and 8, respectively). The data values 9 through 13 are passed from the second register 160b to the register 160c. The data values 3-6 are passed from the register 160c to the register 160 D. The vector 164, including data values 1, 8, 15, are now read from the register 160b on the fourth clock cycle.

In FIG. 15E, on the fifth clock cycle, the next seven data values are read from the memory 140 into slots 5-11 of the register 160 A. Six data values are passed from the register 168 to the register 160b. Five data values are passed from the register 160b to the register 160c. Four data values are passed from the register 160c to the register 160 D. And three data values are passed from the register 160 D to the register 160 E. The next column or vector 164 is now read from the register 160c.

In FIG. 15F, on the sixth clock cycle, the next seven data values are read from the memory 140 into slots 6-12 of the register 160 A. Six data values are passed from the register 168 to the register 160b. Five data values are passed from the register 160b to the register 160c. Four data values are passed from the register 160c to the register 160 D. And three data values are passed from the register 160 D to the register 160 E. two data values are passed from the register 16 CE to the register 160 F. The next column or vector 164, including data values 3, 10, and 17, is now read from the register 160d.

In FIG. 15G, on the seventh clock cycle, the next seven data values are read from the memory 140 into slots 7-13 of the register 160 A. Six data values are passed from the register 168 to the register 160b. Five data values are passed from the register 160b to the register 160c. Four data values are passed from the register 160c to the register 160 D. And three data values are passed from the register 160 D to the register 160 E. two data values are passed from the register 160e to the register 160 F. One data value is passed from the register 160 F to the register 160 G. The next column or vector 164, including data values 4, 11, and 18, is now read from the register 160e.

In FIG. 15H, on the eighth clock cycle, the next seven data values are read from the memory 140 into slots 8-14 of the register 160 A. Six data values are passed from the register 168 to the register 160b. Five data values are passed from the register 160b to the register 160c. Four data values are passed from the register 160c to the register 160 D. And three data values are passed from the register 160 D to the register 160 E. two data values are passed from the register 160e to the register 160 F. One data value is passed from the register 160 F to the register 160 G. The next column or vector 164, including data values 5, 12, and 19, is now read from the register 160f.

In FIG. 15I, on the ninth clock cycle, the next seven data values are read from the memory 140 into slots 1-7 of the register 160 A. Six data values are passed from the register 168 to the register 160b. Five data values are passed from the register 160b to the register 160c. Four data values are passed from the register 160c to the register 160 D. And three data values are passed from the register 160 D to the register 160 E. two data values are passed from the register 160e to the register 160 F. One data value is passed from the register 160 F to the register 160 G. The next column or vector 164, including data 6, 13, and 20, is now read from the register 160g. Though not shown, on subsequent clock cycles, data is again read into the registers from the memory 140 as described above such that after two set up clock cycles, data can then be read from one of the registers on each subsequent clock cycle.

In a generalized sense, in an example in which seven registers are utilized, on each clock cycle N data values is read into a first register from the memory 140. N−1 data values are passed from the first register to the second register. N−2 data values are passed from the second register to the third register, and so forth. Each time new data is written into a register, the starting slot shifts to the left. Some data values are not overwritten due to the shifting. Eventually, the first three data values in a register are ready for reading.

In one embodiment, it is beneficial to consider a number of registers equal to the number of pixels included in a memory location. However this may not always be possible due to their increase. However, it would be possible to find a trade-off for different scenarios. The mechanism will auto align the column data clock cycle after clock cycle, to provide a new data at each Cycle, except for the ones in which the data needs to be recharged. Meanwhile, the new data provides the next data on the first considered register. In this way, the outputs coming from the registers can be sent out one after another using an output selector among them to improve the efficiency of the throughputs and the output bandwidth after the initial latency needed to transfer the initial data into the registers and composed the first column to be sent outside. This is higher in the case of larger kernels to be considered.

In some cases, it is possible that the number registers to be considered is too high. In these cases, it is possible to find a trade-off between the number registers to be used in the number of times the memory locations should be reread. In one example, there are hundred 28 bits of memory with a considered pixel depth of three bits, up to 42 pixels can be stored in a single memory location (leaving out the last bits of the memory word). However, having 42 bits registers with a width larger than 128 can be unfeasible in some circumstances. Accordingly it is impossible to just 27 registers and be the same words seven times reducing the time of reads of the same location can achieve a sum of the previous games and avoiding allocating too much area for the considered unit.

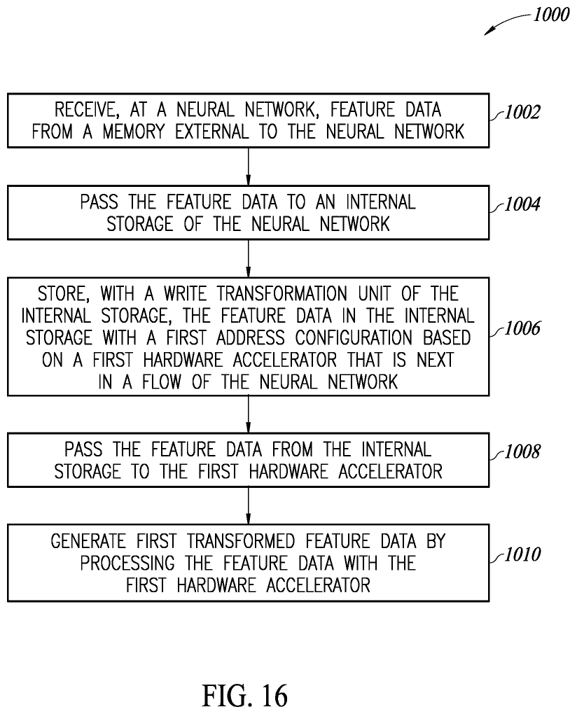

FIG. 16 is a flow diagram of a method 1600, in accordance with one embodiment. The method 1600 may utilize components, systems, and processes described in relation to FIGS. 1-15I. At 1602, the method 1600 includes receiving, at a neural network, feature data from a memory external to the neural network. At 1604, the method 1600 includes passing the feature data to an internal storage of the neural network. At 1606, the method 1600 includes storing, with a write transformer unit of the internal storage, the feature data in the internal storage with a first address configuration based on a first hardware accelerator that is next in a flow of the neural network. At 1608, the method 1600 includes passing the feature data from the internal storage to the first hardware accelerator. At 1610, the method 1600 includes generating first transformed feature data by processing the feature data with the first hardware accelerator.

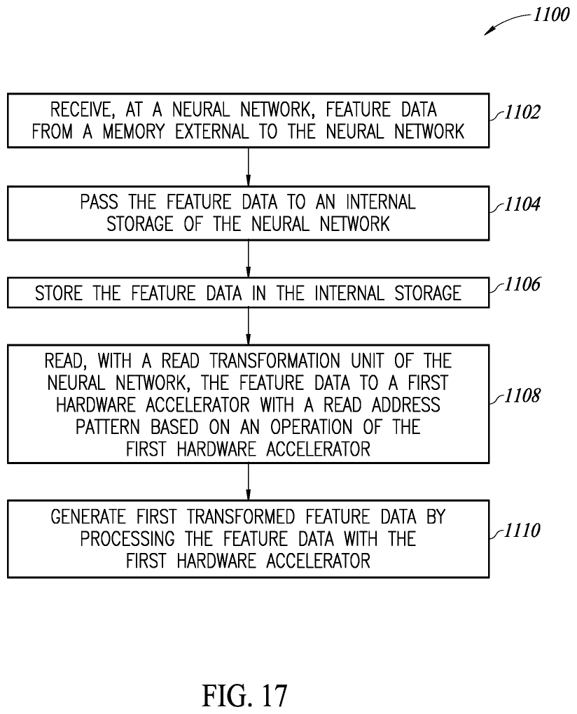

FIG. 17 is a flow diagram of a method 1700, in accordance with one embodiment. The method 1100 may utilize components, systems, and processes described in relation to FIGS. 1-15A. At 1702, the method 1700 includes receiving, at a neural network, feature data from a memory external to the neural network. At 1704, the method 1700 includes passing the feature data to an internal storage of the neural network. At 1706, the method 1700 includes storing the feature data in the internal storage. At 1708, the method 1700 includes reading, with a read transformer unit of the neural network, the feature data to a first hardware accelerator with a read address pattern based on an operation of the first hardware accelerator. At 1710, the method 1700 includes generating first transformed feature data by processing the feature data with the first hardware accelerator.

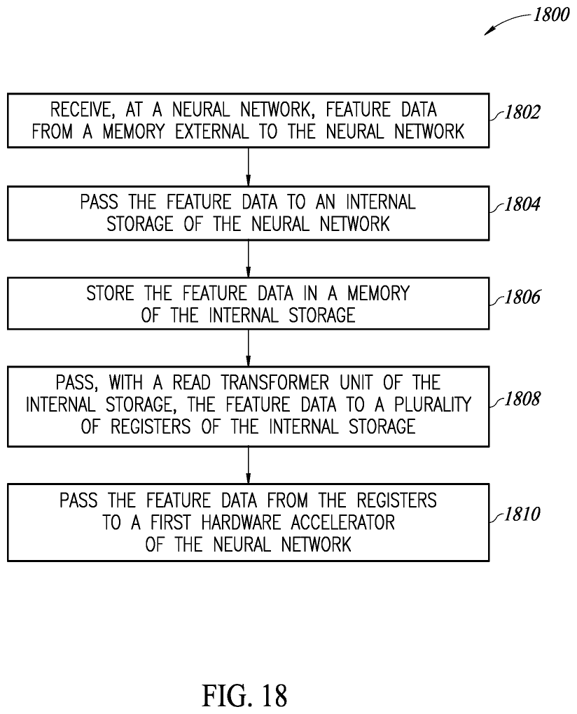

FIG. 18 is a flow diagram of a method 1800, in accordance with one embodiment. The method 1800 may utilize components, systems, and processes described in relation to FIGS. 1-15A. At 1802, the method 1800 includes receiving, at a neural network, feature data from a memory external to the neural network. At 1804, the method 1800 includes passing the feature data to an internal storage of the neural network. At 1806, the method 1800 includes storing the feature data in a memory of the internal storage. At 1808, the method 1800 includes passing, with a read transformer unit of the internal storage, the feature data to a plurality of registers of the internal storage. At 1810, the method 1800 includes passing the feature data from the registers to a hardware accelerator of the neural network.

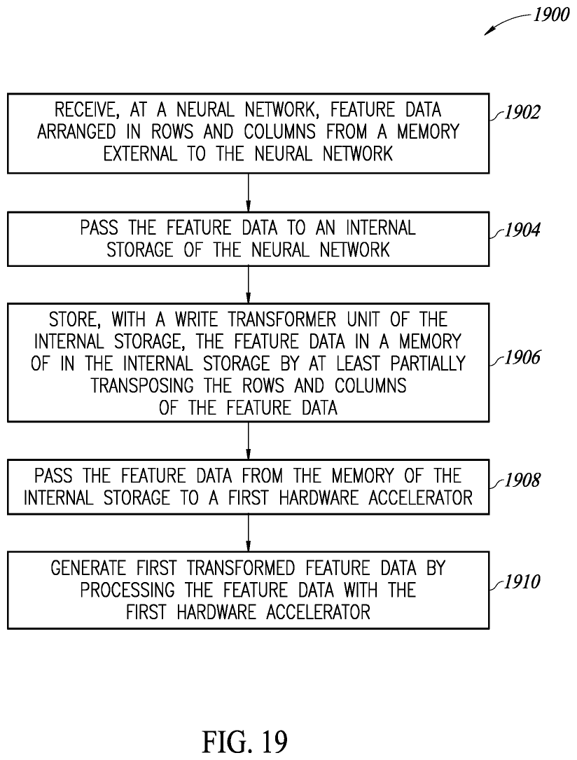

FIG. 19 is a flow diagram of a method 1900, in accordance with one embodiment. The method 1100 may utilize components, systems, and processes described in relation to FIGS. 1-15A. At 1902, the method 1900 includes receiving, at a neural network, feature data arranged in rows and columns from a memory external to the neural network. At 1904, the method 1900 includes passing the feature data to an internal storage of the neural network. At 1906, the method 1900 includes storing, with a write transformer unit of the internal storage, the feature data in a memory of in the internal storage by at least partially transposing the rows and columns of the feature data. At 1908, the method 1900 includes passing the feature data from the memory of the internal storage to a hardware accelerator. At 1910, the method includes generating first transformed feature data by processing the feature data with the hardware accelerator.

In one embodiment, a method includes receiving, at a neural network, feature data from a memory external to the neural network, passing the feature data to an internal storage of the neural network, and storing, with a write transformer unit of the internal storage, the feature data in the internal storage with a first address configuration based on a first hardware accelerator that is next in a flow of the neural network. The method includes passing the feature data from the internal storage to the first hardware accelerator and generating first transformed feature data by processing the feature data with the first hardware accelerator.

In one embodiment, a method includes receiving, at a neural network, feature data from a memory external to the neural network and passing the feature data to an internal storage of the neural network. The method includes storing the feature data in the internal storage and reading, with a read transformer unit of the neural network, the feature data to a first hardware accelerator with a read address pattern based on an operation of the first hardware accelerator. The method includes generating first transformed feature data by processing the feature data with the first hardware accelerator.

In one embodiment, a device includes a neural network. The neural network includes a stream engine configured to receive feature data from a memory external to the neural network, a hardware accelerator, and an internal storage configured to receive the feature data from the stream engine. The internal storage includes a write transformer unit configured to write the feature data into the internal storage with a write address pattern based on a configuration of the hardware accelerator. The internal storage includes a read transformer unit configured to read the feature data to the hardware accelerator with a read address pattern based on the configuration of the hardware accelerator, the hardware accelerator configured to receive the feature data from the internal storage, to process the feature data to generate transformed feature data.

In one embodiment, a method includes receiving, at a neural network, feature data from a memory external to the neural network, passing the feature data to an internal storage of the neural network, and storing the feature data in a memory of the internal storage. The method includes passing, with a read transformer unit of the internal storage, the feature data to a plurality of registers of the internal storage and passing the feature data from the registers to a hardware accelerator of the neural network.

In one embodiment, a method includes receiving, at a neural network, feature data arranged in rows and columns from a memory external to the neural network and passing the feature data to an internal storage of the neural network. The method includes storing, with a write transformer unit of the internal storage, the feature data in a memory of in the internal storage by at least partially transposing the rows and columns of the feature data. The method includes passing the feature data from the memory of the internal storage to a hardware accelerator and generating first transformed feature data by processing the feature data with the hardware accelerator.

In one embodiment, a device includes a neural network. The neural network includes a stream engine configured to receive feature data from a memory external to the neural network, a hardware accelerator, and an internal storage configured to receive the feature data from the stream engine. The internal storage includes a memory configured store the feature data, a plurality of registers coupled to the memory, and a read transformer unit configured to read the feature data to the hardware accelerator including passing the feature data from the memory to the plurality of registers.

Some embodiments may take the form of or comprise computer program products. For example, according to one embodiment there is provided a computer readable medium comprising a computer program adapted to perform one or more of the methods or functions described above. The medium may be a physical storage medium, such as for example a Read Only Memory (ROM) chip, or a disk such as a Digital Versatile Disk (DVD-ROM), Compact Disk (CD-ROM), a hard disk, a memory, a network, or a portable media article to be read by an appropriate drive or via an appropriate connection, including as encoded in one or more barcodes or other related codes stored on one or more such computer-readable mediums and being readable by an appropriate reader device.

Furthermore, in some embodiments, some or all of the methods and/or functionality may be implemented or provided in other manners, such as at least partially in firmware and/or hardware, including, but not limited to, one or more application-specific integrated circuits (ASICs), digital signal processors, discrete circuitry, logic gates, standard integrated circuits, controllers (e.g., by executing appropriate instructions, and including microcontrollers and/or embedded controllers), field-programmable gate arrays (FPGAs), complex programmable logic devices (CPLDs), etc., as well as devices that employ RFID technology, and various combinations thereof.

The various embodiments described above can be combined to provide further embodiments. These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1-20. (canceled)

21. A method, comprising:
receiving, at a neural network, feature data from a memory external to the neural network;
passing the feature data to an internal storage of the neural network;
storing the feature data in a memory of the internal storage;
passing, with a read transformer unit of the internal storage, the feature data to a plurality of registers of the internal storage; and
passing the feature data from the registers to a hardware accelerator of the neural network.

22. The method of claim 21, wherein passing the feature data from the registers to the hardware accelerator includes passing the feature data from the registers to one or more buffers of the internal storage.

23. The method of claim 21, wherein passing the feature data to the plurality of registers includes passing, on each of a plurality of clock cycles, N data values to a first register of the plurality of registers.

24. The method of claim 23, wherein the plurality of registers includes N registers.

25. The method of claim 23, comprising passing, on each clock cycle, N−1 data values from the first register to a second register of the plurality of registers.

26. The method of claim 25, comprising passing, on each clock cycle, N−2 data values from the second register to a third register of the plurality of registers.

27. The method of claim 23, comprising shifting, on each clock cycle, a set of data locations of the first register that receive the N data values.

28. The method of claim 23, comprising, after a plurality of setup clock-cycles, successively reading a data set of the feature data from the registers on each clock cycle.

29. The method of claim 23, comprising passing a non-overlapping portion of the feature data from the memory to the first register on each clock cycle.

30. The method of claim 21, wherein storing the feature data in a memory of the internal storage includes storing, with a write transformer unit of the internal storage, the feature data in the memory of in the internal storage by at least partially transposing the rows and columns of the feature data.

31. The method of claim 30, wherein passing, with a read transformer unit of the internal storage, the feature data to the plurality of registers includes passing at least a portion of each of N rows of the memory to a respective register from the plurality of registers.

32. The method of claim 31, wherein passing the feature data from the registers includes reading a data set from each register on successive clock cycles in an alternating manner.

33. A method, comprising:
receiving, at a neural network, feature data arranged in rows and columns from a memory external to the neural network;
passing the feature data to an internal storage of the neural network;
storing, with a write transformer unit of the internal storage, the feature data in a memory of in the internal storage by at least partially transposing the rows and columns of the feature data;
passing the feature data from the memory of the internal storage to a hardware accelerator; and
generating first transformed feature data by processing the feature data with the hardware accelerator.

34. The method of claim 33, wherein passing the feature data from the memory of the internal storage includes reading, on each clock cycle, a data set entirely from a single row of the memory.

35. The method of claim 33, wherein the at least partially transposing includes storing multiple columns of the feature data in a single row of the memory.

36. The method of claim 33, wherein storing the feature data in the memory includes storing multiple pixels of a column of the feature data in a single data location of the memory.

37. The method of claim 33, wherein the hardware accelerator is a convolution accelerator.

38. A device comprising a neural network, the neural network including:
a stream engine configured to receive feature data from a memory external to the neural network;
a hardware accelerator; and
an internal storage configured to receive the feature data from the stream engine, the internal storage including:
a memory configured store the feature data;
a plurality of registers coupled to the memory; and
a read transformer unit configured to read the feature data to the hardware accelerator including passing the feature data from the memory to the plurality of registers.

39. The device of claim 38, wherein the internal storage includes a write transformer unit configured to write the feature data into the memory with a write address pattern based on a configuration of the hardware accelerator.

40. The device of claim 38, wherein the internal storage includes a control unit configured to control the read transformer unit.
